(19) United States
(12) Patent Application Publication
(10) Pub. No.: US 2019/0272620 A1
(43) Pub. Date: Sep. 5, 2019

(54) SYSTEM AND METHOD FOR IMAGE UPSCALING

(71) Applicant: Jared Siegwarth SEIP, San Francisco, CA (US)

(72) Inventor: Jared Siegwarth SEIP, San Francisco, CA (US)

(21) Appl. No.: 15/912,246

(22) Filed: Mar. 5, 2018

(51) Int. Cl. G06T 3/40; G06N 3/08

(52) U.S. Cl. CPC G06T 3/4046; G06N 3/08

(57) ABSTRACT

A system and method for training a neural network to perform image upscaling is provided. The method includes receiving first, second and third image data at a processor. The processor generates input image data and target image data to feed as a training pair to a neural network processor. In particular, at least one of the first, second and third image data is generated from a high quality imaging device, such as a high resolution thermal camera, or a high resolution RADAR sensor. The neural network processor applies an image upscaling function to the input image data, and minimizes a loss function between upscaled output image data and the target image data to train the neural network. Subsequently, the high quality imaging device may be removed from the system, and the neural network may upscale input image data to approximate image data achieved with the high quality imaging device.

### FIELD

The specification relates generally to image upscaling, and specifically to a system and method for image upscaling across disparate imaging systems using neural networks.

### BACKGROUND

Obtaining high quality images, including video and still images, requires high quality (high resolution) imaging devices. Such high quality imaging devices, such as high resolution thermal imaging devices, may be quite costly.

### SUMMARY

An aspect of the specification provides a method of training a neural network to perform image upscaling. The method includes receiving first image data, second image data and third image data at a processor. The processor generates input image data based on at least one of the first image data, the second image data, and the third image data. The processor further generates target image data based on at least one of the first image data, the second image data, and the third image data. An image upscaling function is applied by the neural network to the input image data to generate upscaled output image data. The neural network compares the upscaled output image data to the target image data to generate learning data; the learning data is applied to update parameters of the image upscaling function to train the neural network.

Another aspect of the specification provides an imaging system. The imaging system includes a memory for storing image data, a network interface, a processor interconnected with the memory and the network interface, and a neural network interconnected with the memory and the processor. The network interface is configured to receive first image data, second image data and third image data and store the image data in the memory. The processor is configured to generate input image data and target image data based on at least one of the first image data, the second image data and the third image data. The neural network is configured to apply an image upscaling function to the input image data to generate upscaled output image data, compare the upscaled output image data to the target image data to generate learning data, and apply the learning data to update parameters of the image upscaling function.

A further aspect of the specification provides a non-transitory computer readable medium encoded with instructions executable by a processor. Execution of the instructions directs the processor to receive first image data, second image data and third image data. The processor is further directed to generate input image data based on at least one of the first image data, second image data, and third image data. The processor is further directed to generate target image data based on at least one of the first image data, the second image data and the third image data. The processor is further directed to apply an image upscaling function to the input image data to generate upscaled output image data. The processor is further directed to compare the upscaled output image data to the target image data to generate learning data. The processor is further directed to apply the learning data to updated parameters of the image upscaling function.

### BRIEF DESCRIPTIONS OF THE DRAWINGS

Embodiments are described with reference to the following figures, in which:

FIG. 1 depicts an example imaging system according to a non-limiting embodiment;

FIG. 2 depicts certain internal components of an imaging server of the imaging system of FIG. 1;

FIG. 3 depicts a method of training a neural network to perform image upscaling in the imaging system of FIG. 1

FIG. 4 depicts a schematic diagram of data flow in the imaging system of FIG. 1 during the method of FIG. 3;

FIG. 5 depicts an example imaging system according to another non-limiting embodiment;

FIG. 6 depicts a method of image upscaling in the imaging system of FIG. 5;

FIG. 7 depicts a schematic diagram of data flow in the imaging system of FIG. 5 during the method of FIG. 6.

### DETAILED DESCRIPTION

A system and method of training a neural network to perform image upscaling is provided. The system includes a high resolution optical camera, a low resolution thermal camera, and a high resolution thermal camera. The imaging system further includes an imaging server configured to interface with the optical camera, the low resolution thermal camera, and the high resolution thermal camera. In particular, the imaging server includes a processor to perform image processing, and a neural network to perform image upscaling. The processor receives a high resolution optical image and a high resolution thermal image and generates a target image, for example, by overlaying the high resolution optical image and the high resolution thermal image. The neural network receives a training pair including the target image and input images. In particular, the input includes the high resolution optical image and the low resolution thermal image. The neural network is configured to upscale the input and minimize a loss function between the upscaled input and the target image. Thus, the neural network is trained to receive a high resolution optical image and a low resolution thermal image and upscale the input to approximate the overlay of the high resolution optical image with the high resolution thermal image.

Subsequently, the high resolution thermal camera may be removed from the system, so that, according to another embodiment, an imaging system for image upscaling including a high resolution optical camera and a low resolution thermal camera is provided. The imaging system further includes an imaging server configured to interface with the optical camera and the low resolution thermal camera. In particular, the imaging server includes a processor to perform image processing, and a neural network, trained as described above, to perform image upscaling. Thus, the neural network receives a high resolution optical image and a low resolution thermal image, and generates upscaled output image data. In particular, the upscaled output image data approximates the overlay of the high resolution optical image data with the high resolution thermal image data without having access to the high resolution thermal image data.

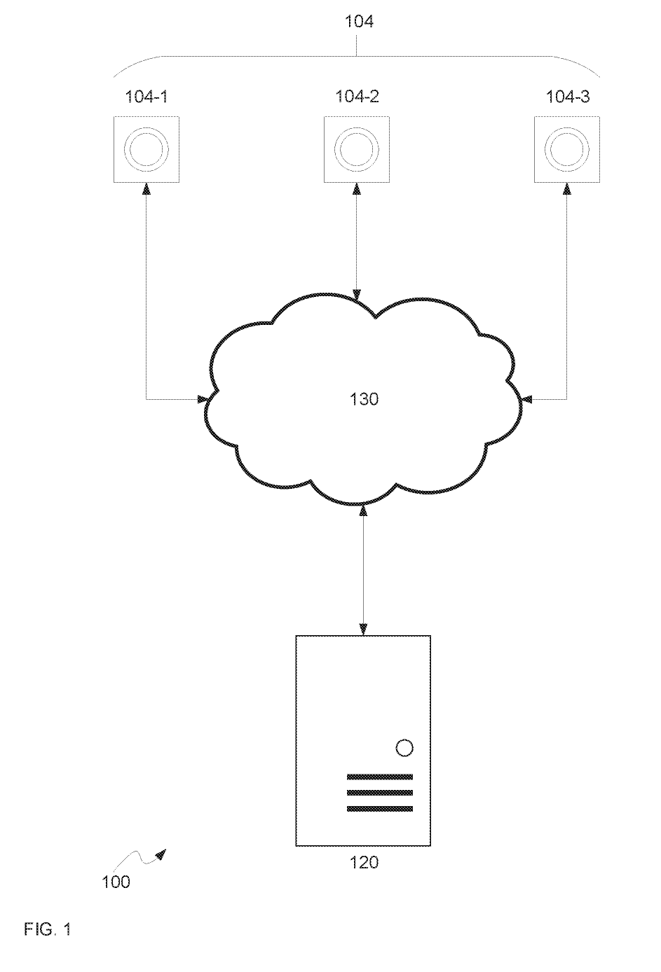

FIG. 1 depicts an imaging system 100, including a plurality of imaging devices 104. In particular, FIG. 1 illustrates a first imaging device 104-1, a second imaging device 104-2, and a third imaging device 104-3. Each imaging device 104 is coupled to a respective processing module (not shown) to control operation of the imaging device 104 and to record input from the imaging device 104 for transmission to the other components of the system 100. In some embodiments, the processing modules may be integrated with the imaging devices 104, while in other embodiments the processing modules may be separate from the imaging devices 104.

In the present example, the first imaging device 104-1 is a low fidelity, or low resolution thermal camera, the second imaging device 104-2 is a high fidelity, high resolution optical camera, and the third imaging device 104-3 is a high fidelity, high resolution thermal camera. In other embodiments, other combinations of imaging devices 104 are contemplated. For example, the imaging devices 104 may be any one of, or a suitable combination of optical cameras (i.e. capturing visible light), thermal cameras (i.e. capturing near-infrared and infrared radiation), RADAR (radio detection and ranging) sensors, LIDAR (light detection and ranging) sensors, ultrasonic sensors, x-ray sensors, and the like. In some embodiments, more than three imaging devices 104 can be provided.

The system 100 also includes an imaging server 120 (also referred to herein as server 120) interconnected with the imaging devices 104 via network 130 (e.g. via a wireless access point, router, or other networking device). The server 120 may be based on any suitable server computing environment; examples of certain internal components of the server 120 will be discussed below. The network 130 can include any one of, or any combination of, a local area network (LAN) defined by one or more routers, switches, wireless access points or the like. The network 130 may also include any suitable wide area network (WAN) including cellular networks and the Internet. The links between the components of the system 100, may be either wired or wireless, or a combination of wired and wireless. In other embodiments, the imaging server 120 can be interconnected with the imaging devices 104 via a direct communications link (e.g. a Universal Serial Bus, USB connection or a Bluetooth™ connection).

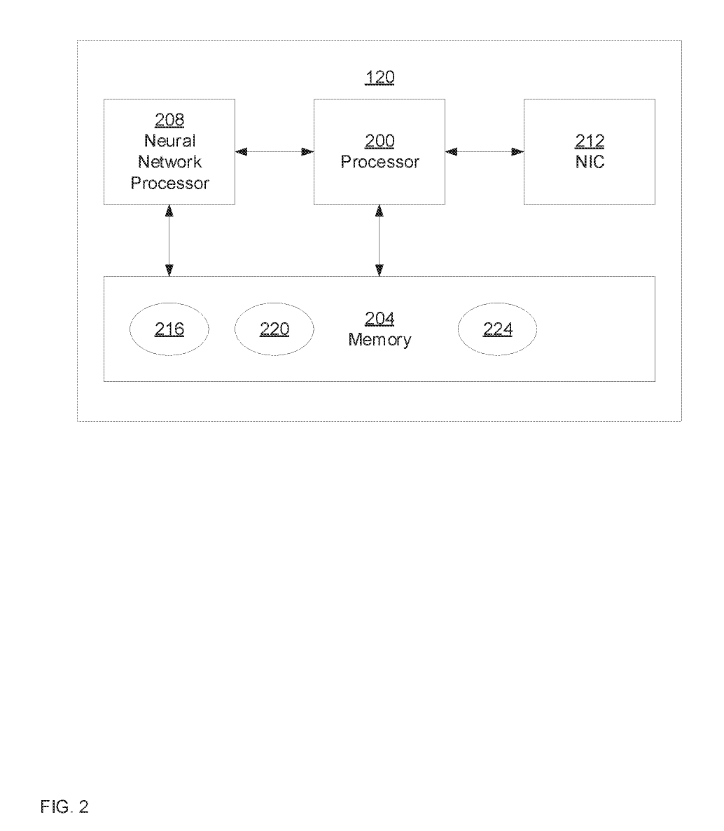

Referring to FIG. 2, the server 120 includes a processor 200, also referred to herein as a central processing unit (CPU), interconnected with a memory 204 and a neural network processor 208. The processor 200, the memory 204, and the neural network processor 208 are generally comprised of one or more integrated circuits (ICs) and can have a variety of structures, as will now occur to those skilled in the art (for example, more than one CPU can be provided).

The memory 204 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory.

The processor 200 is also interconnected with one or more network interfaces, such as a network interface controller (NIC) 212, which allows server 120 to connect with other computing devices, such as imaging devices 104 via the network 130. The NIC 212 thus includes hardware to communicate via the network 130. The server 120 can also include input devices (not shown) interconnected with the processor 200, such as a keyboard and mouse, as well as output devices (not shown) interconnected with the processor 200, such as a display. In some embodiments, the input and output devices can be connected to the processor 200 via the NIC 212 and another computing device. In other words, input and output devices can be local to server 120, or remote.

The neural network processor 208, also referred to herein as the neural network 208, is configured to form a neural network system to execute the various functions described herein. In some embodiments, the neural network processor 208 may be integrated with the processor 200, while in other embodiments, the neural network processor 208 may be separate. The neural network 208 can apply any suitable neural network system or combination of neural network systems, such as feedforward neural networks, regulatory feedback networks, recurrent neural networks and the like. Specifically, neural networks adapted for image processing, such as convolutional neural networks, capsule networks or large memory storage and retrieval neural networks, may be used.

The memory 204 stores a plurality of computer-readable programming instructions, executable by the processor 200 and the neural network processor 208, in the form of various applications, and also stores various types of data for use during the execution of those applications. As will be understood by those skilled in the art, the processor 200 and the neural network processor 208 may execute the instructions of one or more of such applications in order to perform various actions defined within the instructions. In the description below, the processor 200, the neural network processor 208 or the server 120 are said to be “configured to” perform certain functions. It will be understood that the server 120 is so configured via the execution of the instructions of the applications stored in the memory 204 by the processor 200 or the neural network processor 208. Among the applications stored in the memory 204 is an image preparation application 216, a learning application 220, and an image upscaling application 224. The image preparation application 216 is executable by the processor 200, and the learning application 220 and the image upscaling application 224 are executable by the neural network processor 208 to perform various actions described herein. In other embodiments, the image preparation application 216, the learning application 220, and the image upscaling application 224 may be integrated into a single application having modules executable by the processor 200 and the neural network processor 208.

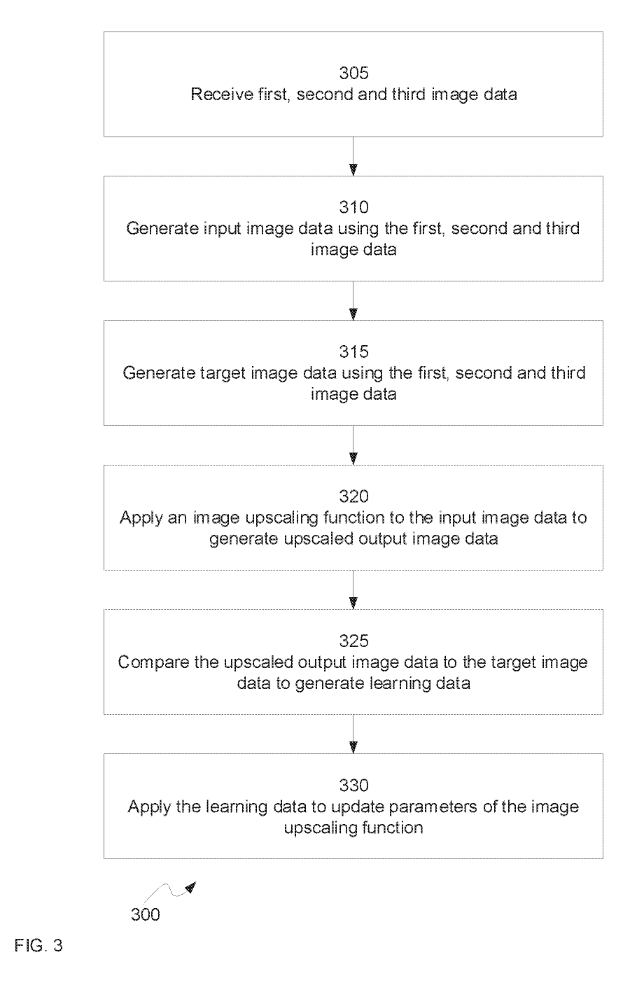

Referring now to FIG. 3, a method 300 of training the neural network processor 208 to perform image upscaling is depicted. The method 300 will be described in conjunction with its performance in the system 100, although it is contemplated that the method 300 can also be performed by other suitable systems. In particular, the blocks of the method 300 are performed by the server 120, via the execution of the image preparation application 216 and the learning application 220.

At block 305, the server 120 is configured to receive first, second and third image data respectively from first, second and third imaging devices 104-1, 104-2, and 104-3, for example via network 130. The image data received at block 305 may include any one of, or any suitable combination of, a stream of video data, a video file, a plurality of still images, and the like, captured by imaging devices 104. Upon receipt of the image data, the server 120 is configured to store the image data in the memory 204 for further processing.

Returning to FIG. 3, at block 310, the server 120, and in particular the processor 200, is configured to generate input image data based on at least one of the first, second and third image data received at block 305. For example, in some embodiments, the input image data comprises the first image data and the second image data. In particular, the input image data may contain the first image data and the second image data as separate image data. In other embodiments, the input image data may comprise a combination of the first image data and the second image data. For example, the combination may be the first image data overlaid with the second image data. In other embodiments, the combination may comprise a blend of the first image data and the second image data, such as by adding the pixel values of each of the image data, or other suitable blending schemes as will be apparent to those of skill in the art.

At block 315, the server 120, and in particular the processor 200 is configured to generate target image data based on at least one of the first, second, and third image data received at block 305. In some embodiments, the target image data comprises a combination of the second image data and the third image data. In particular, the target image data may be the second image data overlaid with the third image data. In other embodiments, the combination may comprise a blend of the second image data and the third image data, such as by adding the pixel values of each of the image data, or other suitable blending schemes. In other embodiments, the target image data may comprise the third image data.

Generally, the image data are combined in such a way to generate training examples for the neural network processor 208. Each training example comprises a pair defining the input (the input image data) and the desired output (the target image data). Hence, generally, to train the neural network processor 208 to perform image upscaling, at least one of the image data may comprise high resolution image data to generate the target image data. The other image data may be representative of expected input for the image upscaling by the neural network processor 208, hence, input image data may be generated from low cost or low resolution image data.

At block 320, the server 120, and in particular the neural network processor 208, is configured to apply an image upscaling function to the input image data to generate upscaled output image data. Generally, the image upscaling function upscales the input image data to approximate the target image data.

At block 325, the server 120, and in particular the neural network processor 208, is configured to compare the upscaled output image data to the target image data to generate learning data. For example, the comparison may comprise minimizing a loss function between the upscaled output image data and the target image data.

At block 330, the server 120, and in particular the neural network processor 208, applies the learning data to update parameters of the image upscaling function. The learning data is generated and applied to update the parameters of the image upscaling function so that if the same input image data were to be passed through the image upscaling function, the resulting upscaled output image data will more closely approximate the target image data than the initial upscaled output image data. Further, as described below, by applying learning data across sets of different training pairs, the image upscaling function may be applied to new input image data to approximate target image data, without having to provide the target image data.

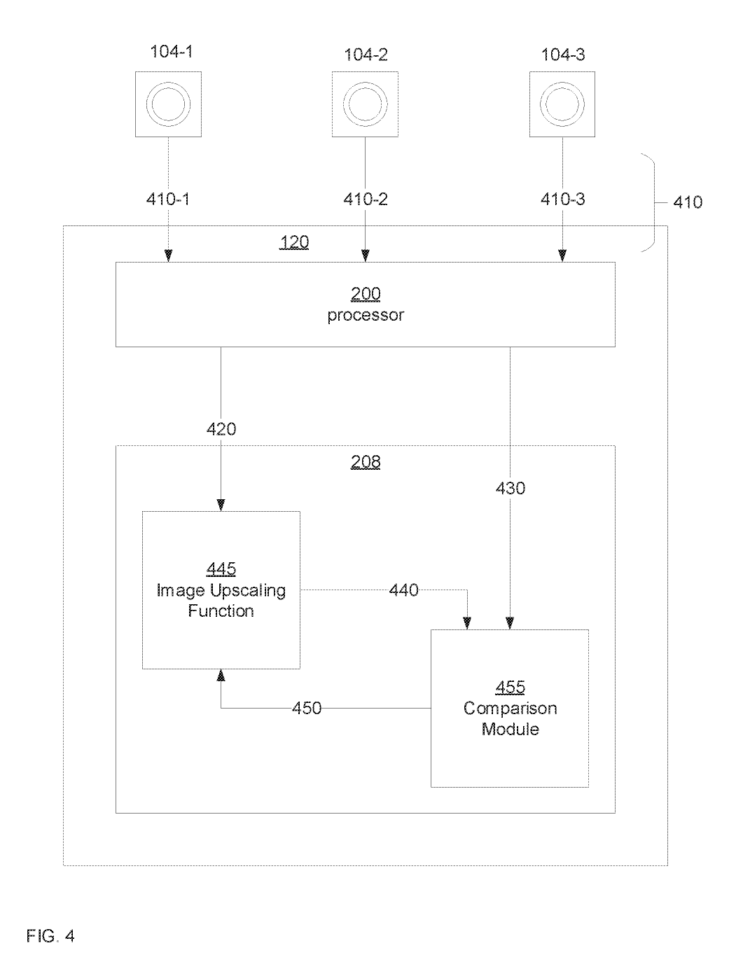

FIG. 4 depicts a schematic diagram of the flow of data in the system 100 when executing the method 300. The imaging devices 104 are configured to capture images corresponding to image data 410. Specifically, imaging devices 104-1, 104-2, and 104-3 generate first image data 410-1, second image data 410-2 and third image data 410-3 respectively. The first, second and third image data 410-1, 410-2, and 410-3 is received by the server 120, and in particular, at the processor 200.

The processor 200 generates input image data 420, and target image data 430 from the first image data 410-1, the second image data 410-2, and the third image data 410-3.

The processor 200 may further be configured to align the image data 410. Specifically, the image data 410 may be aligned such that respective corresponding pixels in the first image data 410-1, the second image data 410-2 and the third image data 410-3 correspond to a same reference point. Thus, the input image data 420 may include pixels common to both the first image data 410-1 and the second image data 410-2, and not pixels occurring in only the first image data 410-1 or only in the second image data 410-2.

In a further embodiment, the processor 200 may align the image data include pixels common to the image data 410-1, 410-2, and 410-3, and may exclude pixels missing from at least one of the image data 410-1, 410-2 or 410-3. Thus, the input image data 420 and the target image data 430 may be internally aligned, as well as aligned with each other such that the same pixels are represented in both the input image data 420 and the target image data 430.

The neural network processor 208 is configured to receive the input image data 420 and the target image data 430. The neural network processor 208 applies an image upscaling function 445 to the input image data 420, resulting in upscaled output image data 440. The upscaled output image data 440 together with the target image data 430 are compared in a comparison module 455 to generate learning data 450. In some embodiments, the comparison module 455 may generate the learning data 450 by applying a loss function between the upscaled output image data 440 and the target image data 430 and minimizing the loss function. The neural network processor 208 then applies the learning data 450 to update the parameters of the image upscaling function 445.

In some embodiments, the neural network processor 208 may receive a set of training pairs comprising input image data 420 and target image data 430. The comparison module 455 may generate the learning data 450 based on the loss function between each input image data 420 and target image data 430. Thus the learning data 450 may represent the minimized loss function of the set of training pairs as a whole. The learning data 450 is applied to update the parameters of the image upscaling function 445 such that the overall performance of the image upscaling function 445 over the set of training pairs improves.

In other embodiments, the comparison module 455 may generate learning data 450 corresponding to subsets of the set of training pairs. Thus the learning data 450 may represent the minimized loss function of a subset of training pairs. The learning data 450 is applied to update the parameters of the image upscaling function 445 such that the overall performance of the image upscaling function 445 over the subset of training pairs improves. Subsequently, the comparison module 455 may generate further learning data based on a further subset of the set of training pairs. The further learning data represents the minimized loss function of the further subset of training pairs. The further learning data is also applied to update the parameters of the image upscaling function 445 such that the overall performance of the image upscaling function 445 over the further subset of training pairs improves.

In an embodiment, the imaging device 104-1, such as a low resolution thermal camera, generates first image data 410-1 such as low resolution thermal image data; the imaging device 104-2, such as a high resolution optical camera, generates second image data 410-2, such as high resolution optical image data; and the imaging devices 104-3, such as a high resolution thermal camera, generates third image data 410-3, such as high resolution thermal image data. The input image data 420 is generated from the first image data 410-1 and the second image data 410-2, i.e., the low resolution thermal image data, and the high resolution optical image data. The target image data is generated from the second image data 410-2 overlaid with the third image data 410-3, i.e. the high resolution optical image data overlaid with the high resolution thermal image data.

Hence, the neural network processor may be configured to update the image upscaling function 445 so that the upscaled output image data 440 (generated from the input image data 420 containing the low resolution thermal data and the high resolution optical image data) approximates the target image data 430 generated from the high resolution optical image data overlaid with the high resolution thermal image data.

In another embodiment, the imaging device 104-1, such as a first low resolution RADAR sensor, generates first image data 410-1, such as first low resolution RADAR image data; the imaging device 104-2, such as a second low resolution RADAR sensor, generates second image data 410-2, such as second low resolution RADAR image data; and the imaging device 104-3, such as a high resolution RADAR sensor, generates third image data 410-3, such as high resolution RADAR image data. The input image data 420 is generated from the first image data 410-1 and the second image data 410-2, i.e. the first low resolution RADAR image data and the second low resolution RADAR image data. The target image data 430 is generated from the third image data 410-3, i.e., the resolution RADAR image data.

Hence, the neural network processor may be configured to update the image upscaling function 445 so that the upscaled output image data (generated from the input image data 420 containing the first low resolution RADAR data and the second low resolution RADAR data) approximates the target image data 430 generated from the high resolution RADAR data. More generally, the system may include several low resolution sensors, with the neural network trained to use the low resolution sensors to approximate a high resolution sensor.

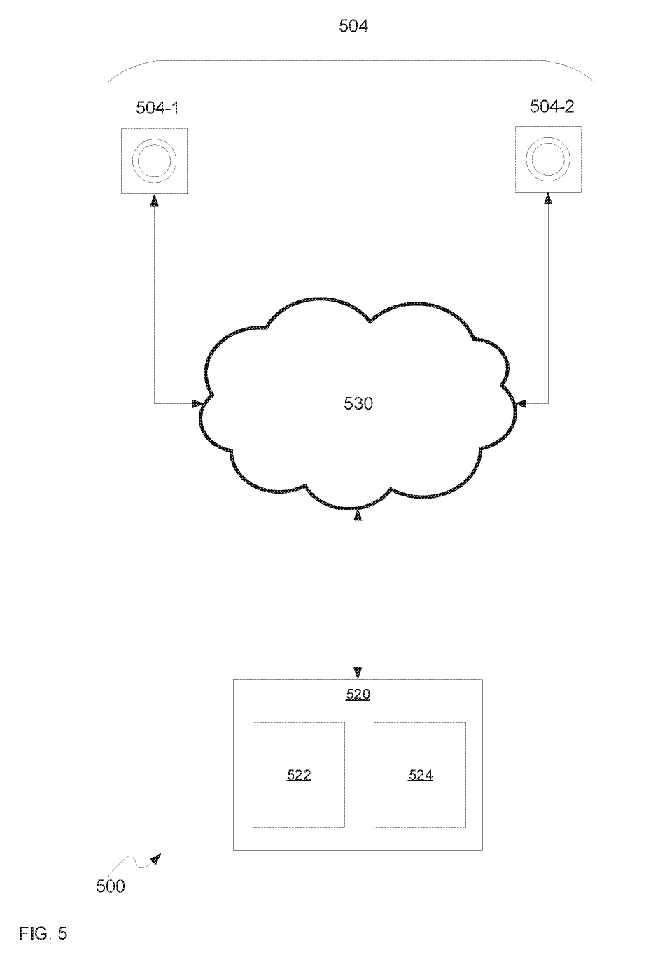

FIG. 5 depicts an imaging system 500, according to another non-limiting embodiment, including a plurality of imaging devices 504. In particular, FIG. 1 illustrates a first imaging device 504-1 and a second imaging device 504-2. Each imaging device 504 is coupled to a respective processing module (not shown) to control operation of the imaging device 504 and to record input from the imaging device 504 for transmission to other components of the system 500. In some embodiments, the processing modules may be integrated with the imaging devices 504, while in other embodiments, the processing modules may be separate from the imaging devices 504. The imaging devices 504 may be any one of, or a suitable combination of optical cameras, thermal cameras, RADAR sensors, LIDAR sensors, ultrasonic sensors, x-ray sensors, and the like. In some embodiments, more than two imaging devices 504 may be provided.

The system also includes an imaging server 520 (also referred to as server 520) interconnected with the imaging devices 504 via a network 530 (e.g. via a wireless access point, router, or other networking device). The server 520 may be based on any suitable server computing environment and may include a processor 522, a memory (not shown) and a neural network processor 524.

The processor 522, the memory and the neural network processor 524 are generally comprised of one or more integrated circuits (ICs) and can have a variety of structures, as will occur to those skilled in the art. The processor 522 is also interconnected with one or more network interfaces (not shown), such as a network interface controller (NIC), which allows the server 520 to connect with other computing devices, such as the imaging devices 504 via the network 530. The server 520 can also include input devices (not shown) interconnected with the processor 522, such as a keyboard and mouse, as well as output devices (not shown) interconnected with the processor 522, such as a display. In some embodiments, the input and output devices can be connected to the processor 522 via the NIC and another computing device. In other words, input and output devices can be local to server 520, or remote.

The neural network processor 524, also referred to herein as the neural network, is configured to form a neural network system to execute the various functions described herein. In some embodiments, the neural network processor 524 may be integrated with the processor 522, while in other embodiments, the neural network processor 524 may be separate. The neural network processor 524 can apply any suitable neural network system or combination of neural network systems, such as feedforward neural networks, regulatory feedback networks, recurrent neural networks and the like. Specifically, neural networks adapted for image processing, such as convolutional neural networks, capsule networks or large memory storage and retrieval neural networks, may be used.

The memory can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. The memory stores a plurality of computer-readable programming instructions, executable by the processor 522 and the neural network processor 524, in the form of various applications, and also stores various types of data for use during the execution of those applications. As will be understood by those skilled in the art, the processor 522 and the neural network processor 524 may execute the instructions of one or more of such applications in order to perform various actions defined within the instructions. In the description below, the processor 522, the neural network processor 524 or the server 520 are said to be “configured to” perform certain functions. It will be understood that the server 520 is so configured via the execution of the instructions of the applications stored in the memory by the processor 522 or the neural network processor 524. Among the applications stored in the memory is an image preparation application, a learning application, and an image upscaling application. The image preparation application is executable by the processor 522, and the learning application and the image upscaling application are executable by the neural network processor 524 to perform various actions described herein. In other embodiments, the image preparation application, the learning application, and the image upscaling application may be integrated into a single application having modules executable by the processor 522 and the neural network processor 524.

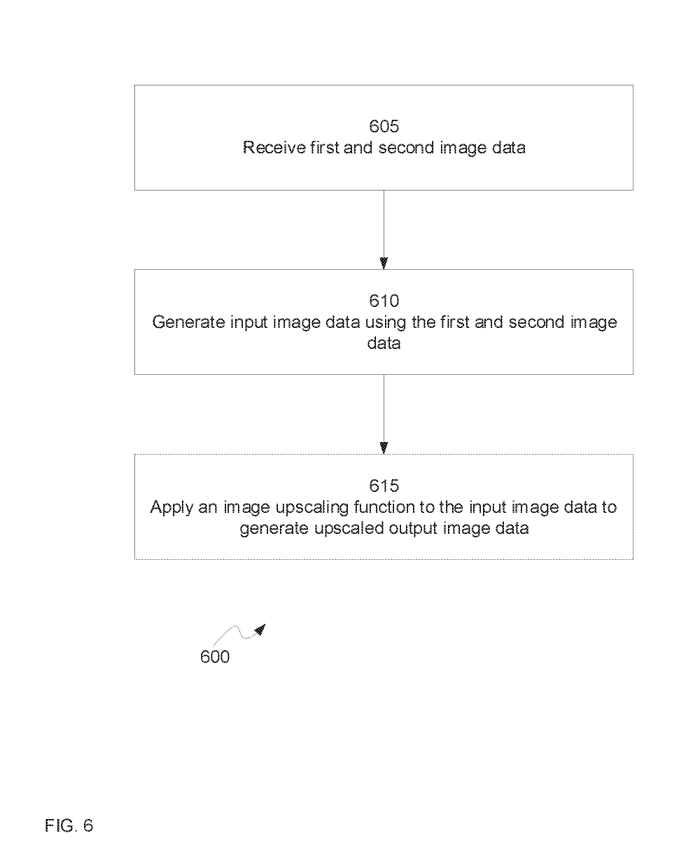

Referring now to FIG. 6, a method 600 of image upscaling using the neural network processor 524 is depicted. The method 600 will be described in conjunction with its performance in the system 500, although it is contemplated that the method 600 can also be performed by other suitable systems, such as the system 100. In particular, the blocks of the method 600 are performed by the server 520, via the execution of the image preparation application and the image upscaling application.

At block 605, the server 520 is configured to receive first and second image data respectively from first and second imaging devices 504-1 and 504-2, for example via network 530. The image data received at block 605 may include any one of, or any suitable combination of a stream of video data, a video file, a plurality of still images, and the like, captured by imaging devices 504. Upon receipt of the image data, the server 520 is configured to store the image data in the memory 204 for further processing.

At block 610, the server 520, and in particular the processor 522 is configured to generate input image data using the first and second image data received at block 605.

At block 615, the server 520, and in particular the neural network processor 208 is configured to apply an image upscaling function to the input image data to generate upscaled output image data.

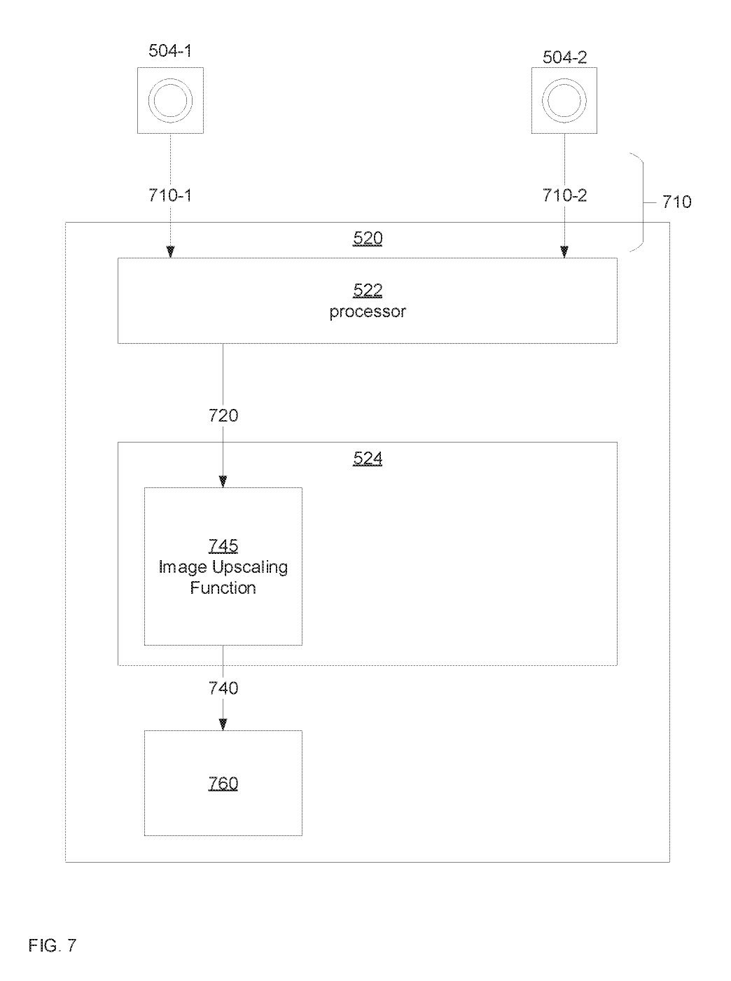

Referring now to FIG. 7, a schematic diagram of the flow of data in the system 500 during the method 600. The imaging devices 504 are configured to capture images corresponding to image data 710. Specifically, imaging devices 504-1 and 504-2 generate first image data 710-1 and second image data 710-2 respectively. The first and second image data 710-1 and 710-2 are received by the server 520.

The processor 522 generates input image data 720 from the first image data 710-1 and the second image data 710-2. In some embodiments, the input image data 720 comprises the first image data 710-1 and the second image data 710-2 as separate image data. In other embodiments, the input image data 720 may comprise a combination of the first image data 710-1 and the second image data 710-2. For example, the combination may be the first image data 710-1 overlaid with the second image data 710-2. In other examples, the combination may comprise a blend of the first image data 710-1 and the second image data 710-2, such as by adding the pixel values of each of the image data, or other suitable blending schemes, as will be apparent to those of skill in the art.

The processor 522 may further be configured to align the image data 710. Specifically, the image data 710 may be aligned such that respective corresponding pixels in the first image data 710-1 and the second image data 710-2 correspond to a same reference point. Thus, the input image data 720 may include pixels common to both the first image data 710-1 and the second image data 710-2, and not pixels occurring in only the first image data 710-1 or in only the second image data 710-2.

The neural network processor 524 is configured to receive the input image data 720 and apply an image upscaling function 745 to the input image data 720, resulting in upscaled output image data 740. The upscaled output image data 740 defines an upscaled output image 760.

In an embodiment, the imaging device 504-1, such as a low resolution thermal camera, generates first image data 710-1, such as low resolution thermal image data; and the imaging device 504-2, such as a high resolution optical camera, generates second image data 710-2, such as high resolution optical image data. The input image data 720 is generated from the first image data 710-1 and the second image data 710-2, i.e., the low resolution thermal image data and the high resolution optical image data. The image upscaling function 745 produces upscaled output image data 740 defining an upscaled output image 760 which approximates a high resolution thermal image overlaid with the high resolution optical image.

In another embodiment, the imaging device 504-1, such as a first low resolution RADAR sensor, generates the first image data 710-1, such as first low resolution RADAR image data; and the imaging device 504-2, such as a second low resolution RADAR sensor, generates the second image data 710-2, such as second low resolution RADAR image data. The input image data 720 is generated from the first low resolution RADAR data and the second low resolution RADAR data. The image upscaling function 745 produces upscaled output image data 740 defining an upscaled output image 760 which approximates a high resolution RADAR image.

In other embodiments, various combinations of types of imaging devices are contemplated. For example, the system and method described herein may be applicable to a combination of night vision and infrared sensors, a combination of LIDAR and optical sensors, a combination of RADAR and LIDAR sensors, a combination of ultrasonic and X-ray sensors, and the like. In particular, each combination may include a high resolution imaging device or sensor, used to train the neural network processor to generate a hybrid image. The high resolution imaging device or sensor may be subsequently removed from the system, once the neural network processor has been trained. Hence, the system may be trained to generate an upscaled hybrid image without use of the high resolution image data.

In further embodiments, the system and method described herein may be applicable to a combination of a series of low resolution imaging devices and a high resolution imaging device in the same spectrum. In particular, the high resolution imaging device may be used to train the neural network processor to generate high resolution image data from the series of low resolution imaging devices. The high resolution imaging device may subsequently be removed from the system once the neural network processor has been trained. Hence, the system may be trained to generate a high resolution image data from the series of low resolution imaging devices (i.e. without the use of the high resolution image data).

Other combinations of imaging devices are also contemplated.

The scope of the claims should not be limited by the embodiments set forth in the above examples, but should be given the broadest interpretation consistent with the description as a whole.

1. A method comprising:
receiving first image data, second image data and third image data;
generating input image data based on at least one of the first image data, the second image data and the third image data;
generating target image data based on at least one of the first image data, the second image data and the third image data;
applying an image upscaling function to the input image data to generate upscaled output image data;
comparing the upscaled output image data to the target image data to generate learning data; and
applying the learning data to update parameters of the image upscaling function.

2. The method of claim 1, wherein the input image data comprises the first image data and the second image data.

3. The method of claim 1, wherein the target image data comprises a combination of the second image data and the third image data.

4. The method of claim 1, wherein the target image data comprises the third image data.

5. The method of claim 1, further comprising:
capturing, by a first imaging device, a first image corresponding to the first image data;
capturing, by a second imaging device, a second image corresponding to the second image data; and
capturing, by a third imaging device, a third image corresponding to the third image data.

6. The method of claim 1, further comprising aligning the first image data, the second image data and the third image data such that respective corresponding pixels in the first image data, the second image data, and the third image data correspond to a same reference point.

7. The method of claim 1, wherein the comparing comprises minimizing a loss function between the upscaled output image data and the target image data to generate the learning data.

8. An imaging system comprising:
a memory for storing image data;
a network interface configured to receive first image data, second image data and third image data and store the image data in the memory;
a processor interconnected with the memory and the network interface, the processor configured to:
generate input image data based on at least one of the first image data, the second image data and the third image data; and
generate target image data based on at least one of the first image data, the second image data and the third image data; and
a neural network interconnected with the processor, the neural network configured to:
apply an image upscaling function to the input image data to generate upscaled output image data;
compare the upscaled output image data to the target image data to generate learning data; and
apply the learning data to update parameters of the image upscaling function.

9. The imaging system of claim 8, wherein the input image data comprises the first image data and the second image data.

10. The imaging system of claim 8, wherein the target image data comprises a combination of the second image data and the third image data.

11. The imaging system of claim 8, wherein the target image data comprises the third image data.

12. The imaging system of claim 8, further comprising:
a first imaging device to capture a first image corresponding to the first image data, wherein the first image data is to be transmitted to the processor;
a second imaging device to capture a second image corresponding to the second image data, wherein the second image data is to be transmitted to the processor; and
a third imaging device to capture a third image corresponding to the third image data, wherein the third image data is to be transmitted to the processor.

13. The imaging system of claim 8, wherein the processor is further configured to align the first image data, the second image data and the third image data such that respective corresponding pixels in the first image data, the second image data, and the third image data correspond to a same reference point.

14. The imaging system of claim 8, wherein the neural network is further configured to compare the upscaled output image data to the target image data by minimizing a loss function between the upscaled output image data and the target image data to generate the learning data.

15. A non-transitory computer readable medium encoded with instructions executable by a processor, wherein execution of the instructions directs the processor to:
receive first image data, second image data and third image data;
generate input image data based on at least one of the first image data, the second image data and the third image data;
generate target image data based on at least one of the first image data, the second image data and the third image data;
apply an image upscaling function to the input image data to generate upscaled output image data;
compare the upscaled output image data to the target image data to generate learning data; and
apply the learning data to update parameters of the image upscaling function.

16. The non-transitory computer readable medium of claim 15, wherein the input image data comprises the first image data and the second image data.

17. The non-transitory computer readable medium of claim 15, wherein the target image data comprises a combination of the second image data and the third image data.

18. The non-transitory computer readable medium of claim 15, wherein the target image data comprises the third image data.

19. The non-transitory computer readable medium of claim 15, wherein the execution of the instructions further directs the processor to align the first image data, the second image data, and the third image data such that respective corresponding pixels in the first image data, the second image data and the third image data correspond to a same reference point.

20. The non-transitory computer readable medium of claim 15, wherein the execution of the instructions further directs the processor to minimize a loss function between the upscaled output image data and the target image data to generate the learning data.
